(19) United States
(12) Patent Application Publication
(10) Pub. No.: US 2016/0217653 A1
(43) Pub. Date: Jul. 28, 2016

(54) SPORTS BETTING MODEL

(71) Applicant: David M. Beyer, Gilbertsville, PA (US)

(72) Inventor: David M. Beyer, Gilbertsville, PA (US)

(21) Appl. No.: 14/976,395

(22) Filed: Dec. 21, 2015

Related U.S. Application Data
(60) Provisional application No. 62/106,784, filed on Jan. 23, 2015.

(51) Int. Cl. G07F 17/32

(52) U.S. Cl. CPC G07F 17/3227; G07F 17/3288

(57) ABSTRACT

A sports betting system for creating and processing a sports betting entertainment for a plurality of sports bettors. The sports bettors select a plurality of sporting contests from the at least one sporting category. The sports bettors select at least one of the plurality of sports teams as a winning team in each of the plurality of sporting contests. The at least one of the plurality of sports bettors is selected as the won bettor when the plurality of sports teams selected by the at least one of the plurality of sports bettors has won in the plurality of sporting contests. The sports betting entertainment created by the sports betting system is derived from combining several sporting events from a specific category or specific categories into a single betting opportunity and requiring the bettor to successfully select the winner in a daily specified required number of contests.

### BACKGROUND OF THE DISCLOSURE

1. Technical Field of the Disclosure

The present embodiment relates generally to sports betting models, and more particularly to a sports betting system that combines several sporting events from a specific category or specific categories into a single betting opportunity and that enables sports bettors to select winners from a multiple number of sports games.

2. Description of the Related Art

Sports betting are a popular way of earning money in a gambling industry that provides entertainment and increased viewership to sports fans and spectators. In Sports betting, the bettors predict game winners and place a wager on the outcome of the game. Generally, sports bets are of two types: fixed odds and tote odds. In fixed odds, the amount to be paid by the betting system is determined only at the time of wager in tote odds, all the participating bets are pooled and the winning bets share the pool, Usually, in these conventional types of betting methods, the sports bets are placed prior to the start of an event. In addition to these methods, another type called “in-play betting” also has been very popular. The in-play betting process bets on an outcome after the commencement of an event. Exotic bet is another type of in-play betting which refers to a bet made on a situation that may or may not happen during the processing of an event. Yet another type of betting is arbitrage betting where each outcome of an event is bet upon so that a known profit is made by the bettor after the completion of the event, regardless of the outcome.

Sports betting is commonly conducted in sports like football, soccer, horse or dog racing, basketball and the like utilizing a telephone, interactive television, Internet and smartphone applications. With the advent of Internet technology and other electronic distribution methods, online sports betting methods have become very popular in the interactive gaming markets. The online sports betting methods are designed to be more interactive which enables the customers to gamble with joysticks and controls. Certain sports betting models even help the government to collect taxes from the betting organizers and whiners. These smarter money betting methods are customized as simple and thrilling depending upon the type of audience. The simple sports betting models are very easy to play and are more suitable for the casual bettor who participates in sports gambling for relaxation rather than for thrills.

A wide variety of methods have been developed to facilitate the sports betting process. For example, one method describes a system that creates virtual events within a virtual world. A virtual event may be akin to a real event, but is completely computer generated within a computer-generated world and is based on statistical measures, either real world or created. Numerous characteristics about the competitors and the competition location parameters are available before a competition event. Based on the known parameters about the location of an event and the characteristics of the participants and their historical past performances in similar events enable bettors to make informed wagers on an event that greatly enhances the satisfaction and involvement in a competition event. However, this method demands specialized knowledge for a sports bettor on various sports gaming aspects like points, dollars, or goals, to succeed in this sports betting process.

Another method describes a system for enabling a fantasy sports betting system with a server for transmitting odds, displays and results data; a memory device that receives and stores user input and sporting event outcome data in a non-transitory computer readable medium; and a processor that processes user input and sporting event outcome data according to at least one game of the system. However, this system does not provide a second betting chance for picking a sports team if the first chance failed because of technical issues in the system, or a natural calamity.

Yet another method describes a sport and event wagering system. This system allows pari-mutuel wagering with respect to new areas other than horse or dog racing, expanding the sports wagering industry to encompass other areas of interest and enjoyment to bettors. Specifically, pari-mutuel wagering is enabled with respect to the performance statistics of individual sport or event participants, combinations of sport participants, combinations of event participants, and sports teams. However, this sports and event wagering system only allows a sport bettor to predict winners from one sporting contest which can result in smaller payouts to the bettor.

Another betting method exists in which a sports bettor picks a single digit to integer, or number from “0” to “9”. Predetermined criterion numbers are summed and the least significant digit of the sum is compared to the selected integer to determine winners. The system includes adding the numerical values of the numbers of the winning positions of the entrants (typically first, second and third), with the least significant digit of the sum or total being compared with the bettor's selected number, However, this betting method is difficult to understand, so a sports bettor with substantial knowledge of the sporting events may not be able to bet effectively and successfully.

Therefore, there is a need for a sports betting method that is easy to understand for a sports bettor with limited knowledge of the sporting events involved. Such a needed method would allow a sports bettor to predict winners from a multiple number of sporting contests providing potentially larger payouts to the bettors. Further, such a needed method would provide a free credit for selecting winning sports teams to a bettor if the first bet failed because of technical issues or a natural calamity. Such a needed method would attract increased interest of sports bettors and spectators. Moreover, such a needed method would allow the sports betting houses to balance the sporting contests without spending much time and money. Such a needed method would be deployed via Internet in a manner that extends the reach of the sports betting houses. Furthermore, such a needed method would not charge a betting fee or a commission due to its higher profit margins. The present embodiment accomplishes these objectives.

### SUMMARY OF THE DISCLOSURE

To minimize the limitations found in the prior art, and to minimize other limitations that will be apparent upon the reading of the specification the preferred embodiment of the present invention provides a sports betting system and a method for creating and processing a sports betting entertainment for a plurality of sports bettors.

The sports betting system comprises a processor having a bet processing module and a memory unit integrated with a sports betting database. The memory unit is coupled with the processor. The sports betting system enables the plurality of sports bettors to select at least one sporting category utilizing a web based betting platform in installed on an electronic device. The plurality of sports bettors selects the at least one sporting category via a network. The plurality of sports bettors selects the plurality of sporting contests from the at least one sporting category. The plurality of sports bettors is allowed to select the plurality of sporting contests from the at least one sporting category one to seven times a week. When the plurality of sports teams from several different categories are combined, numerous different betting opportunities are concurrently offered.

A count of daily contests to be conducted on a specific day is determined by each of the plurality of sports bettors. A plurality of sports bets is placed by the plurality of sports bettors via the web based betting platform. This is achieved by selecting at least one of the plurality of sports teams as a winning team in each of the plurality of sporting contests by the plurality of sports bettors. The at least one sporting category, the plurality of sporting contests, the count of daily contests and the plurality of sports bets are stored at the sports betting database. The plurality of sports bettors submits the plurality of sports bets placed by each of the plurality of sports bettors to the bet processing module at the processor via the web based betting platform before the commencement of the plurality of sporting contests. The bet processing module accepts the plurality of sports bets. The bet processing module rejects the at least one of the plurality of sports bets if the plurality of sports bettors had submitted the plurality of sports bets after the commencement of the plurality of sporting contests.

The specified number of daily contests is conducted within planned time duration in real time outside the sports betting system. After the completion of the plurality of sporting contests, results of the plurality of sports teams are informed via the network by the bet processing module to each of the plurality of sports bettors. The plurality of sports bets is retrieved from the sports betting database to determine the at least one won bettor. The results of the plurality of sports teams are compared with the plurality of sports bets submitted by each of the plurality of sports bettors. Finally, the at least one of the plurality of sports bettors is selected as the won bettor when the plurality of sports teams selected by the at least one of the plurality of sports bettors has won in the plurality of sporting contests. If all the sports teams predicted by the at least one of the plurality of sports bettors become the winners in all the sporting contests then those sports bettors becomes the winner in the sports betting method. Preferably, the web based betting platform selects the at least one won bettor without any handicapping points, goals or dollars. The at least one won bettor is rewarded with payments by the bet processing module via the web based betting platform.

The bet processing module declares the selection of the at least one won bettor as incorrect when at least one of the plurality of sporting contests ends in a tie except in the contests of pro soccer where the result of the sporting contests is a win or a tie but cannot be both. The sports bettors whose predicted sports teams got failed in the sporting contests become non-winning bettors. The bet processing module rejects payments to the non-winning bettors. In the preferred embodiment, the successful sports bettors win large payouts for a small bet. Further, the sports betting houses do not have to spend as much time and money in balancing the sporting contests. Due to higher profit margins, the sports betting houses do not have to charge a betting fee or a commission, to encourage more fan bets.

The preferred system and method allows the participant to pick only winning teams daily from Sunday through Saturday as long as there are enough competitive sporting contests to offer choices daily in a specific category or specific categories. The sports betting model is the creation and processing of a betting opportunity derived from combining several sporting events from a specific category or specific categories into a single betting opportunity and requiring the bettor to successfully pick the winner in a daily specified required number of contests except in contests of Pro Soccer where the winning pick can be a win or a tie but cannot be both, without any handicapping points, goals, or dollars.

One added advantage of the preferred embodiment is that, the method provides a free credit for picking winning sports teams to a sports bettor if the first chance of winner prediction got failed in case of natural calamity such as rainout, national emergency, lighting failure, earthquakes, fires or floods, a sports bettor would then receive a free credit to select the at least one of the sports teams.

In accordance with another exemplary embodiment of the present invention, a non-transitory computer-readable medium comprises computer-executable instructions stored therein for causing a computer to implement a program executable on a sports betting system for creating and processing a sports betting entertainment for a plurality of sports bettors.

A first objective of the present invention is to provide a sports betting system that is easy to understand for a sports bettor with limited knowledge of the sporting contests involved,

A second objective of the present invention is to provide a sports betting system that allows a sports bettor to predict winners from a multiple number of sporting contests providing potentially larger payouts to the bettors.

A third objective of the present invention is to provide a sports betting system that provides a free credit for picking winning sports teams to a bettor if the first bet failed because of technical issues or a natural calamity.

A fourth objective of the present invention is to provide a sports betting system that attracts increased interest of sports bettors and spectators.

A fifth objective of the present invention is to provide a sports betting system that allows the sports betting houses to balance the sporting contests without spending much time and money.

A sixth objective of the present invention is to provide a sports betting system deployed via Internet in a manner that extends the reach of the sports betting houses.

A seventh objective of the present invention is to provide a sports betting system that does not charge a betting fee or a commission due to its higher profit margins.

An eighth objective of the present invention is to provide a sports betting system that will encourage more fan bets.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a high level block diagram of a sports betting system for creating and processing a sports betting entertainment for a plurality of sports bettors in accordance with an embodiment of the present invention;

FIG. 2 illustrates a high level flowchart of a method for creating and processing the sports betting entertainment for the plurality of sports bettors utilizing the sports betting system; and

FIG. 3 illustrates a flowchart for selecting at least one of the plurality of sports bettors as a won bettor.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

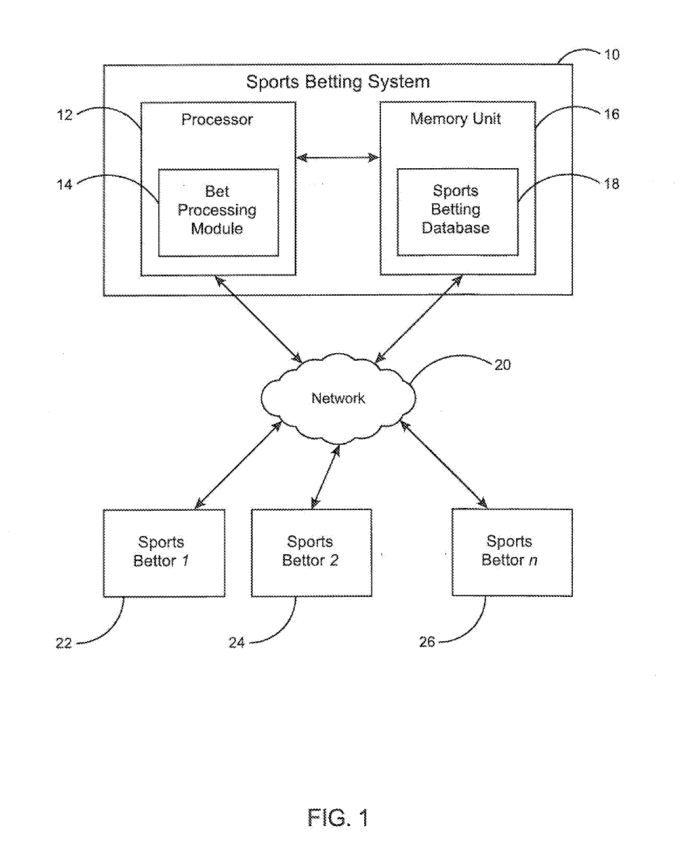

Referring to FIG. 1 of the drawings, a sports betting system for creating and processing a sports betting entertainment for a plurality of sports bettors according to the present invention is illustrated and generally designated by the reference numeral 10. The sports betting system 10 comprises a processor 12 having a bet processing module 14 and a memory unit 16 integrated with a sports betting database 18. The memory unit 16 is coupled to the processor 12. The preferred sports betting system 10 enables the plurality of sports bettors to select at least one sporting category utilizing a web based betting platform installed on an electronic device via a network 20. The sports betting system 10 is adaptable to provide betting service to any number of plurality of sports bettors represented as sports bettor1 22, sports bettor2 24 up to sports bettor-n 26 as illustrated in FIG. 1. The plurality of sports bettors selects a plurality of sporting contests from the at least one sporting category. The at least one sporting category includes pro football, college football pro basketball, college basketball, pro baseball, pro soccer and pro hockey. Each of the plurality of sporting contests includes a plurality of sports teams. The sports bettors 22, 24 and 26 select their favorite sports teams through the electronic device. The electronic device is selected from a group consisting of: a smart phone, a laptop, a personal computer, a tablet computing device and a hand-held digital media communication device.

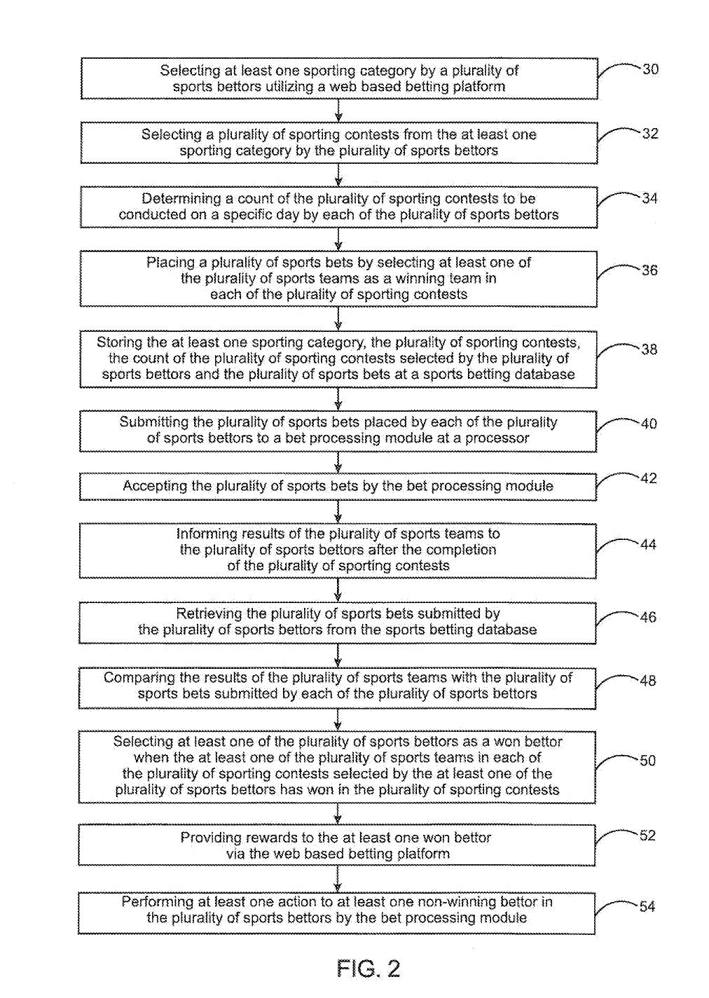

Referring to FIG. 2, a method for creating and processing the sports betting entertainment is illustrated. As shown in block 30, the plurality of sports bettors selects the at least one sporting category utilizing the web based betting platform via the network. Next, the plurality of sporting contests from the at least one sporting category is selected by the plurality of sports bettors as shown in block 32. In the preferred embodiment, the plurality of sports bettors is allowed to select the plurality of sporting contests from the at least one sporting category one to seven times a week.

A count of daily contests to be conducted on a specific day is determined by each of the plurality of sports bettors as indicated at block 34. Thereafter, a plurality of sports bets is placed by the plurality of sports bettors via the web based betting platform as shown in block 36. This is achieved by selecting at least one of the plurality of sports teams as a winning team in each of the plurality of sporting contests by the plurality of sports bettors. When the plurality of sports teams from several different categories are combined, numerous different betting opportunities are concurrently offered. Next, the at least one sporting category, the plurality of sporting contests, the count of daily contests and the plurality of sports bets are stored at the sports betting database as indicated at block 38. The plurality of sports bettors submits the plurality of sports bets placed by each of the plurality of sports bettors to the bet processing module at the processor via the web based betting platform before the commencement of the plurality of sporting contests as indicated at block 40. The bet processing module accepts the plurality of sports bets as shown in block 42. The bet processing module rejects the at least one of the plurality of sports bets if the plurality of sports bettors had submitted the plurality of sports bets after the commencement of the plurality of sporting contests.

The specified number of daily contests is conducted within planned time duration in real time outside the system 10. As indicated at block 44, after the completion of the plurality of sporting contests, results of the plurality of sports teams are informed via the network by the bet processing module to each of the plurality of sports bettors. Next step is to determine at least one won bettor winner among the plurality of sports bettors. In order to determine the at least one won bettor, the plurality of sports bets is retrieved from the sports betting database as shown at block 46. Thereafter, the results of the plurality of sports teams are compared with the plurality of sports bets submitted by each of the plurality of sports bettors as indicated at block 48, Finally, the at least one of the plurality of sports bettors is selected as the won bettor when the plurality of sports teams selected by the at least one of the plurality of sports bettors has won in the plurality of sporting contests as shown in block 50. To be more clear, if all the sports teams predicted by the at least one of the plurality of sports bettors become the winners in all of the sporting contests then those sports bettors becomes the winner in the sports betting method. The web based betting platform selects the at least one won bettor without any handicapping points, goals or dollars. The at least one won bettor is rewarded with payments by the bet processing module via the web based betting platform as shown in block 52. In one embodiment of tie present invention, the rewards may be gift vouchers, entry tickets for tour packages and Sports events, special discounts for various products and services in malls and supermarkets.

The bet processing module declares the selection of the at least one won bettor as incorrect when at least one of the plurality of sporting contests ends in a tie except in the contests of pro soccer where the result of the sporting contests is a win or a tie but cannot be both. The sports bettors whose predicted sports teams got failed in the sporting contests become non-winning bettors. The bet processing module performs at least one action to the non-winning bettors as indicated at block 54. The at least one action includes rejecting the rewards to the non-winning bettors.

One added advantage of the preferred embodiment is that, the method provides a free credit for picking winning sports teams to a sports bettor if the first chance of winner prediction got failed in case of natural calamity such as rainout. national emergency, lighting failure, earthquakes, fires or floods, a participant would then receive a free credit for another selection to select the at least one of the sports teams or another bet on a potential winning sports team. This free credit can be used within thirty days from the date of the canceled contest or the opportunity to pick again is lost.

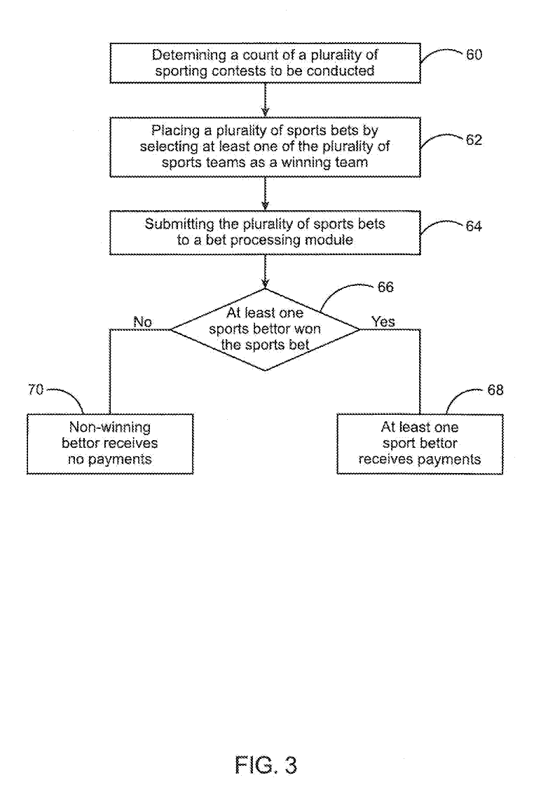

FIG. 3 illustrates a method for selecting the at least one of the plurality of sports bettors as the won bettor. As shown in block 60, the count of daily contests to be conducted on a specific day is determined by each of the plurality of sports bettors. The plurality of sports bettors places the plurality of sports bets by selecting the at least one of the plurality of sports teams as the winning team as illustrated at block 62. The plurality of sports bets is submitted to the bet processing module as shown in block 64, The sports bets should be submitted before the commencement of the actual sporting contents. If any sports bet failed to submit before the commencement of the sporting contest then that sports bet is not allowable and gets rejected by the bet processing module. A visualization of allowable bets is made available to potential bettors and a plurality of sports betting houses. These visualizations include, but are not limited to, printed media with a list of allowable bets and an Internet interface showing allowable bets.

Thereafter, the system 10 performs a check to determine whether the at least one sports bettor has won the sports bet or not as shown in block 66. If the plurality of sports teams selected by the at least one of the plurality of sports bettors has won in the plurality of sporting contests then those sports bettors become the winners. These won bettors receive rewards in the form of payments from the bet processing module as shown in block 68. If any of the selected sports teams fail then the corresponding sports bettors become non-winning bettors and receive no payments as indicated at block 70.

In the preferred sports betting system 10, the successful sports bettors win large payouts for a small bet. Further, the sports betting houses do not have to spend as much time and money in balancing the sporting contests. Due to higher profit margins, the sports betting houses do not have to charge a betting fee or a commission, to encourage more fan bets. The simplicity of the invention allows it to be deployed via the Internet in a manner that extends the reach of the sports betting houses.

A sample representation of total chance of favorite teams winning is shown in Table 1.

TABLE 1

| | | | | | | | Total | |
|---|---|---|---|---|---|---|---|---|
| | | | | | | | Chance | |
| | | | | | | | of | |
| | | | | | | | Favorites | |
| | First | Second | Third | Fourth | Fifth | Sixth | Not | Payout |
| Bets | Contest | Contest | Contest | Contest | Contest | Contest | Winning | 6 to 1 |
| | 25% | 25% | 25% | 25% | 10% | 10% | | |
| | 1 | 3 | 7 | 15 | 31 | 63 | 120 | |
| 1 | 0.25 | 0.75 | 1.75 | 3.75 | 3.10 | 6.30 | 15.90 | 6 |
| 2 | 0.00 | 0.50 | 1.50 | 3.50 | 3.00 | 6.20 | 14.70 | 6 |
| 3 | 0.00 | 0.25 | 1.25 | 3.25 | 2.90 | 6.10 | 13.75 | 6 |
| 4 | 0.00 | 0.00 | 1.00 | 3.00 | 2.80 | 6.00 | 12.80 | 6 |
| 5 | 0.00 | 0.00 | 0.75 | 2.75 | 2.70 | 5.90 | 12.10 | 6 |

If a sports bettor choses all six slightly favored teams, the odds of the bettor winning this bet will be 15.90 to 1, where it is calculated that, four of the slightly favored teams win three out of four contests and two of the slightly favored teams win nine out of ten contests. With the planned payout to winning participants of $6.00 for a $1.00 bet, the anticipated profit margin would be 9.90/15.90=62.26%.

In one embodiment, a non-transitory computer-readable medium comprises computer-executable instructions stored therein for causing a computer to implement a program executable on a sports betting system 10 for creating and processing a sports betting entertainment for a plurality of sports bettors. The non-transitory computer readable storage medium comprises a USB memory, CD-ROM, flexible disc, DVD or a flash memory. In one embodiment, a non-transitory computer readable medium comprises computer-executable instructions stored therein for causing mobility solutions to implement a program executable on a sports betting system 10 to create and process a sports betting entertainment for a plurality of sports bettors.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method for creating and processing a sports betting entertainment for a plurality of sports bettors utilizing a sports betting system residing on a computer having a processor coupled with a memory unit integrated with a sports betting database via a network, the method comprising the steps of:
(a) selecting at least one sporting category by the plurality of sports bettors it utilizing a web based betting platform installed on an electronic device;
(b) selecting a plurality of sporting contests from the at least one sporting category by the plurality of sports bettors, each of the plurality of sporting contests includes a plurality of sports teams;
(c) determining a count of daily contests to be conducted on a specific day by each of the plurality of sports bettors;
(d) placing a plurality of sports bets by selecting at least one of the plurality of sports teams as a winning team in each of the plurality of sporting contests by the plurality of sports bettors via the web based betting platform;
(e) storing the at least one sporting category, the plurality of sporting contests, the count of daily contests selected by the plurality of sports bettors and the plurality of sports bets at the sports betting database;
(f) submitting the plurality of sports bets placed by each of the plurality of sports bettors to a bet processing module at the processor via the web based betting platform by the plurality of sports bettors before the commencement of the plurality of sporting contests;
(g) accepting the plurality of sports bets by the bet processing module;
(h) informing results of the plurality of sports teams to the plurality of sports bettors after the completion of the plurality of sporting contests via the network by the bet processing module;
(i) retrieving the plurality of sports bets submitted by the plurality of sports bettors from the sports betting database;
(j) comparing the results of the plurality of sports teams with the plurality of sports bets submitted by each of the plurality of sports bettors;
(k) selecting at least one of the plurality of sports bettors as a won bettor when the at least one of the plurality of sports teams in each of the plurality of sporting contests selected by the at least one of the plurality of sports bettors at step (d) has won in the plurality of sporting contests;
(l) providing rewards to the at least one won bettor via the web based betting platform; and
(m) performing at least one action to at least one non-winning bettor in the is plurality of sports bettors by the bet processing module;
whereby the bet processing module provides an opportunity for the plurality of sports bettors to earn higher payoffs through the selection of a multiple number of winning teams in the plurality of sporting contests.

2. The method of claim 1 wherein the at least one action at step (m) includes rejecting payments to the at least one non-winning bettor when the plurality of sports teams selected by the at least one non-winning bettor did not win in the plurality of sporting contests.

3. The method of claim 1 wherein the at least one sporting category includes pro football, college football, pro basketball, college basketball, pro baseball, pro soccer and pro hockey.

4. The method of claim 1 allows the plurality of sports bettors to select the plurality of sporting contests from the at least one sporting category one to seven times a week.

5. The method of claim 1 wherein the web based betting platform selects the at least one won bettor without any handicapping points, goals or dollars.

6. The method of claim 1 wherein the bet processing module declares the selection of the at least one won bettor as incorrect when at least one of the plurality of sporting contests ends in a tie except in the contests of pro soccer.

7. The method of claim 1 wherein the bet processing module rejects the at least one of the plurality of sports bets if the plurality of sports bettors submits the plurality of sports bets after the commencement of the plurality of sporting contests.

8. The method of claim 1 wherein the electronic device is selected from a group consisting of: a smart phone, a laptop, a personal computer, a tablet computing device and a hand-held digital media communication device.

9. A sports betting system for creating and processing a sports betting entertainment for a plurality of sports bettors, the sports betting system comprises:
a processor having a bet processing module; and
a memory unit coupled with the processor and a sports betting database, the memory unit stores instructions which when executed directs the processor to:
enable the plurality of sports bettors to select at least one sporting category utilizing a web based betting platform installed on an electronic device;
enable each of the plurality of sports bettors to select a plurality of sporting contests from the at least one sporting category, each of the plurality of sporting contests includes a plurality of sports teams;
allow each of the plurality of sports bettors to determine a count of daily contests to be conducted on a specific day;
enable the plurality of sports bettors to place a plurality of sports bets by selecting at least one of the plurality of sports teams as a winning team in each of the plurality of sporting contests via the web based betting platform;
store the at least one sporting category, the plurality of sporting contests, the count of daily contests selected by the plurality of sports bettors and the plurality of sports bets at a sports betting database integrated in the memory unit via a network;
allow the plurality of sports bettors to submit the plurality of sports bets placed by each of the plurality of sports bettors to the bet processing module via the web based betting platform by the plurality of sports bettors before the commencement of the plurality of sporting contests;
enable the bet processing module to accept the plurality of sports bets;
enable the bet processing module to inform results of the plurality of sports teams to the plurality of sports bettors after the completion of the plurality of sporting contests via the network;
enable the bet processing module to retrieve the plurality of sports bets submitted by the plurality of sports bettors from the sports betting database;
allow the bet processing module to compare the results of the plurality of sports teams with the plurality of sports bets submitted by each of the plurality of sports bettors;
allow the bet processing module to select at least one of the plurality of sports bettors as a won bettor when the at least one of the plurality of sports teams in each of the plurality of sporting contests selected by the at least one of the plurality of sports bettors has won in the plurality of sporting contests;
enable the bet processing module to provide rewards to the at least one won bettor via the web based betting platform; and
enable the bet processing module to perform at least one action to at least one non-winning bettor in the plurality of sports bettors;
whereby the bet processing module provides art opportunity for the plurality of sports bettors to earn higher payoffs through the selection of a multiple number of winning teams in the plurality of sporting contests.

10. The sports betting system of claim 9 wherein the at least one action includes rejecting payments to the at least one non-winning bettor when the plurality of sports teams selected by the at least one non-winning bettor did not win in the plurality of sporting contests.

11. The sports betting system of claim 9 wherein the at least one of the sporting category includes pro football, college football, pro basketball, college basketball, pro baseball, pro soccer and pro hockey.

12. The sports betting system of claim 9 allows the plurality of sports bettors to select the plurality of sporting contests from the at least one sporting category one to seven times a week.

13. The sports betting system of claim 9 wherein the web based betting platform selects the at least one won bettor without any handicapping points, goals or dollars.

14. The sports betting system of claim 9 wherein the bet processing module declares the selection of the at least one won bettor as incorrect when at least one of the plurality of sporting contests ends in a tie except in the contests of pro soccer.

15. The sports betting system of claim 9 wherein the bet processing module rejects the at least one of the plurality of sports bets if the plurality of sports bettors submits the plurality of sports bets after the commencement of the plurality of sporting contests.

16. The sports betting system of claim 9 wherein the communication device is selected from a group consisting of a smart phone, a laptop, a personal computer, a tablet computing device and a hand-held digital media communication device.

17. A non-transitory computer-readable medium having computer-readable program code embodied therein which when executed by a computer having a processor and a memory unit causes the computer to perform the following steps:
(a) selecting at least one sporting category by a plurality of sports bettors utilizing a web based betting platform installed on an electronic device;
(b) selecting a plurality of spotting contests from the in least one sporting category by the plurality of sports bettors, each of the plurality of sporting contests includes a plurality of sports teams;
(c) determining a count of daily contests to be conducted on a specific day by each of the plurality of sports bettors;
(d) placing a plurality of sports bets by selecting at least one of the plurality of sports teams as a winning team in each of the plurality of sporting contests by the plurality of sports bettors;
(e) storing the at least one sporting category, the plurality of sporting contests, the count of daily contests selected by the plurality of sports bettors and the plurality of sports bets at a sports betting database in the memory unit via a network;
(f) submitting the plurality of sports bets placed by each of the plurality of sports bettors to a bet processing module at the processor via the web based betting platform by the plurality of sports bettors before the commencement of the plurality of sporting contests:
(g) accepting the plurality of sports bets by the bet processing module;
(h) informing results of the plurality of sports teams to the plurality of sports bettors after the completion of the plurality of sporting contests via the network;
(i) retrieving the plurality of sports bets submitted by the plurality of sports bettors from the sports betting database;
(j) comparing the results of the plurality of sports teams with the plurality of sports bets submitted by each of the plurality of sports bettors;
(k) selecting at least one of the plurality of sports bettors as a won bettor when the at least one of the plurality of sports teams in each of the plurality of sports contests selected by the at least one of the plurality of sports bettors at step (d) has won in the plurality of sporting contests;
(l) providing rewards to the at least one won bettor via the web based betting platform; and
(m) performing at least one action to at least one non-winning bettor in the plurality of sports bettors by the bet processing module;
whereby the bet processing module provides an opportunity for the plurality of sports bettors to earn higher payoffs through the selection of a multiple number of winning teams in the plurality of sporting contests.

18. The non-transitory computer-readable medium of claim 17 wherein the at least one action at step (m) includes rejecting payments to the at least one non-winning bettor when the plurality of sports teams selected by the at least one non-winning bettor did not win in the plurality of sporting contests.

19. The non-transitory computer-readable medium of claim 17 wherein the plurality of sporting categories in hides pro football, college football, pro basketball, college basketball, pro baseball, pro soccer and pro hockey.

20. The non-transitory computer-readable medium of claim 17 allows the plurality of sports bettors to select the plurality of sporting contests from the at least one sporting category one to seven times a week.

21. The non-transitory computer-readable medium of claim 17 wherein the web based betting platform selects the at least one of won bettor without any handicapping points, goals or dollars.

22. The non-transitory computer-readable medium of claim 17 wherein the bet processing module declares the selection of the at least one won bettor as incorrect when at least one of the plurality of sporting contests ends in a tie except in contests of pro soccer.

23. The non-transitory computer-readable medium of claim 17 wherein the bet processing module declares the selection of the at least one won bettor as incorrect when at least one of the plurality of sporting contests ends in a tie except in the contests of pro soccer.

24. The non-transitory computer-readable medium of claim 17 wherein the communication device is selected from a group consisting of a smart phone, a laptop, a personal computer, a tablet computing device and a hand-held digital media communication device.
